(19) United States
(12) Patent Application Publication
(10) Pub. No.: US 2026/0322923 A1
(43) Pub. Date: Oct. 15, 2026

(54) INSPECTION SYSTEM THAT INSPECTS SHEET ON WHICH IMAGE HAS BEEN FORMED

(71) Applicant: CANON KABUSHIKI KAISHA, Tokyo (JP)

(72) Inventor: RIKI FUKUHARA, Chiba (JP)

(21) Appl. No.: 19/634,712

(22) Filed: Mar. 31, 2026

(30) Foreign Application Priority Data
Apr. 10, 2025 (JP) 2025-065204

(51) Int. Cl. H04N 1/00

(52) U.S. Cl. CPC H04N 1/00087; H04N 1/00034; H04N 1/00602; H04N 2201/0094

(57) ABSTRACT

An inspection system includes a conveyance unit that conveys an image-formed sheet, and a reading unit that irradiates the sheet with light from a light-emitting element to read the sheet. The inspection system inspects the sheet based on the read image. The inspection system receives a user setting related to the inspection. Before the sheet is accepted, the inspection system causes the reading unit to measure luminance of a reference member. The inspection system generates calibration data based on this measurement. The inspection system causes the light-emitting element to start light emission after receiving the user setting and before measuring the reference member.

This application claims the benefit of Japanese Patent Application No. 2025-065204, filed Apr. 10, 2025, which is hereby incorporated by reference herein in its entirety.

### BACKGROUND

### Field of the Technology

The present disclosure relates to an inspection system that inspects a sheet on which an image has been formed.

### Description of the Related Art

Conventionally, there has been known an inspection system including an image-forming apparatus which forms an image on a sheet and an inspection apparatus which is arranged downstream of the image-forming apparatus and inspects the sheet during execution of a job. The inspection performed during execution of a job is also called 'inline inspection'. In the inline inspection, the inspection apparatus optically reads a sheet on which an image has been formed, analyzes a read image, and determines whether the image on the sheet is appropriate or not. Typically, a defective sheet that has been determined as having a defect is discharged to a discharge destination that is different from a discharge destination of normal sheets.

The optical reading of a sheet in an inspection apparatus is usually performed by irradiating a sheet with light from a light-emitting element and detecting a reflected light from the sheet by an image sensor. In such an inspection apparatus, it is common to execute calibration before starting and in the middle of a print job so that non-uniformity of a light amount of the light-emitting element and non-uniformity of sensitivity of the image sensor will not result in degradation in inspection accuracy. The calibration is also called 'shading correction'. The shading correction is performed by, for example, optically reading a reflected light from a white reference member to measure non-uniformity in the light amount or the sensitivity, and correcting read images so as to compensate for an impact of the non-uniformity in accordance with the measurement result. Japanese Patent Application Laid-Open No. 2025-001517 proposes to measure luminance of a reference member to obtain calibration data such as correction coefficients or the like at a timing when a time interval between consecutive sheets temporarily becomes longer so that the operation for calibration during execution of a job over a plurality of sheets will not lower productivity.

However, there has been room in inspection to improve obtainment of the calibration data for calibrating reading operations.

### SUMMARY

Embodiments of the disclosure provide an inspection system comprising: a conveyance unit configured to convey a sheet on which an image has been formed by an image-forming apparatus; a reading unit configured to execute a reading operation to irradiate the sheet with light from a light-emitting element and read a reflected light from the sheet; an inspection unit configured to inspect the sheet based on a read image generated as a result of the reading operation; a control unit configured to cause the reading unit to execute a measurement operation to irradiate a reference member with light from the light-emitting element and measure luminance of a reflected light from the reference member before the conveyance unit accepts the sheet; a calibration unit configured to generate calibration data to be used in calibrating the reading operation based on a result of the measurement operation; and a setting unit configured to receive a user setting related to the inspection at the inspection unit. The control unit is configured to cause the light-emitting element to start light emission after the setting unit receives the user setting related to the inspection and before the control unit causes the reading unit to execute the measurement operation.

Features of the present disclosure will become apparent from the following description of embodiments with reference to the attached drawings.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a schematic diagram showing an example of a configuration of an inspection system according to an embodiment.

FIG. 2 is a block diagram showing an example of concrete configurations of control functions of the inspection system according to an embodiment.

FIG. 3A is a first descriptive diagram for describing an example of image inspection.

FIG. 3B is a second descriptive diagram for describing an example of image inspection.

FIG. 4 is a descriptive diagram showing an example of a configuration of a print setting screen according to an embodiment.

FIG. 5 is a descriptive diagram showing an example of a configuration of an inspection setting screen according to an embodiment.

FIG. 6 is a schematic diagram showing an example of configurations of reading units for measuring luminance of reference members.

FIG. 7 is a graph representing an example of a luminance measurement result.

FIG. 8 is a descriptive diagram for describing an example of correction of a light amount using a gain.

FIG. 9 is a first descriptive diagram for describing an example of correction of read pixel values using correction coefficients.

FIG. 10 is a second descriptive diagram for describing an example of correction of read pixel values using correction coefficients.

FIG. 11 is a descriptive diagram for describing enhancement of productivity by preliminary light emission.

FIG. 12 is a flowchart showing an example of a flow of inspection control processing according to an embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### 1. Overview of System

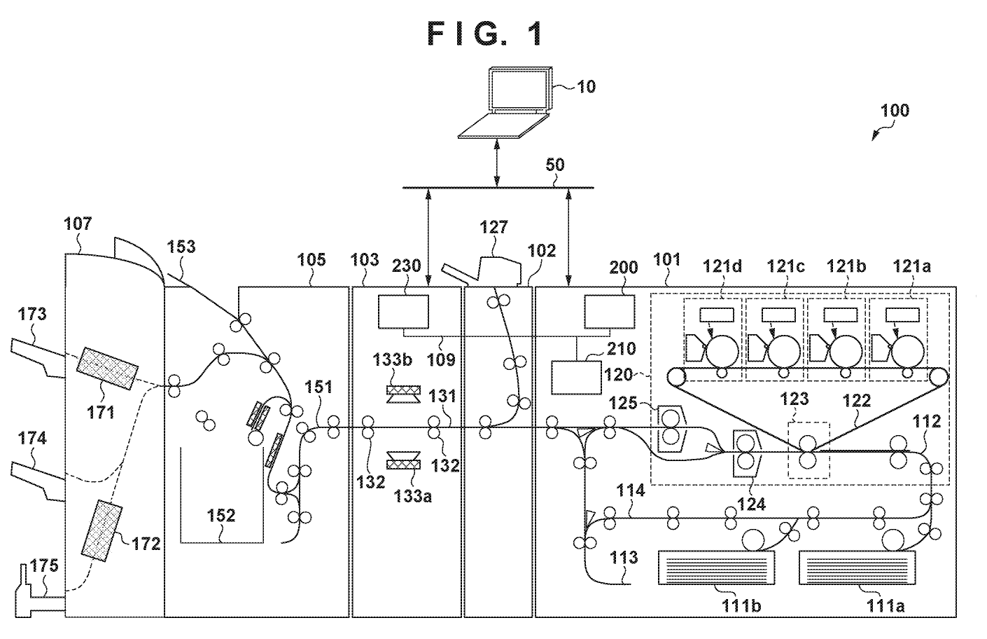

In this section, an overview of a system to which the technology according to the present disclosure may be applied will be described. FIG. 1 is a schematic diagram showing an example of a configuration of an inspection system 100 according to an embodiment. In addition to the inspection system 100, a host computer 10 and a communication network 50 are shown in FIG. 1. In the example of FIG. 1, the inspection system 100 includes an image-forming apparatus 101, an inserter 102, an inspection apparatus 103, a stacker 105, and a finisher 107.

### 1-1. Host Computer

The host computer 10 is an information processing apparatus that is communicatively connected to the inspection system 100 via the communication network 50. The communication network 50 may be any type of network such as a local area network (LAN), the Internet, or a virtual private network (VPN), for example. Although one host computer 10 and one inspection system 100 are shown in FIG. 1, a plurality of host computers 10 may be connected to one inspection system 100. In addition, one host computer 10 may be connected to a plurality of inspection systems 100. The host computer 10 receives a print instruction and input image data from a user, and issues a print job to the inspection system 100.

### 1-2. Image-forming Apparatus

The image-forming apparatus 101 is an apparatus that receives and executes print jobs. The image-forming apparatus 101 may be a printer or a multifunction peripheral (MFP), for example. In the example of FIG. 1, the image-forming apparatus 101 includes paper feeding units 111a, 111b, an image-forming unit 120, and a conveyance mechanism. Each of the paper feeding units 111a and 111b picks up sheets one by one from a bundle of sheets contained therein to feed them to a conveyance path 112.

The image-forming unit 120 is an image-forming unit that forms an image on a sheet. The image-forming unit 120 includes image-making units 121a, 121b, 121c and 121d, an intermediate transfer belt 122, a secondary transfer unit 123, a first fixing unit 124, and a second fixing unit 125. The image-making units 121a, 121b, 121c and 121d form toner images of color components of yellow (Y), magenta (M), cyan (C), and black (K), respectively. As the image-making units 121a, 121b, 121c and 121d have configurations in common with each other, the image-making unit 121a is taken as an example herein to describe the configuration. The image-making unit 121a forms an electrostatic latent image on a surface of a charged photosensitive drum by exposing the photosensitive drum to light (for example, laser beam) modulated in accordance with input image data. The image-making unit 121a also develops the electrostatic latent image to form a yellow toner image by supplying the electrostatic latent image on the surface of the photosensitive drum with toner. The toner images of respective color components formed by the image-making units 121a, 121b, 121c and 121d are sequentially transferred to the intermediate transfer belt 122 in an overlapping manner (primary transfer), and thereby a full-color toner image is formed. The intermediate transfer belt 122 conveys the full-color toner image to a secondary transfer position in synchronization with a timing at which the sheet arrives at the secondary transfer position of the secondary transfer unit 123. The secondary transfer unit 123 transfers the toner image from the intermediate transfer belt 122 to a first surface of the sheet at the secondary transfer position.

The first fixing unit 124 has a roller (or a belt) heated by a heater, and fixes the toner image to the sheet by melting the toner of the toner image while sandwiching and conveying the sheet. Depending on a type of the sheet, the sheet is conveyed to a path that passes through the second fixing unit 125 when further fixing processing is needed. The second fixing unit 125 has a roller (or a belt) heated by a heater, too, and enhances fixability of the toner image to the sheet by sandwiching and conveying the sheet.

When double-sided printing is designated, the sheet is guided to a reverse conveyance path 113 where its movement direction is reversed and it is conveyed to a double-sided conveyance path 114. Then, it returns to the conveyance path 112 with its front and back surfaces inverted, and the secondary transfer unit 123 transfers a toner image to a second surface of the sheet that has arrived at the secondary transfer position. The sheet that has passed through the first fixing unit 124 (and the second fixing unit 125) with toner image(s) fixed to its single or both side(s) is output from the image-forming apparatus 101 to the inserter 102.

### 1-3. Inserter

The inserter 102 accepts a series of sheets sequentially output from the image-forming apparatus 101, and inserts additional sheets at positions designated in the print job. The sheets to be inserted are fed from an insert tray 127 that is at the top of the inserter 102. The series of sheets and the inserted sheets are output from the inserter 102 to the inspection apparatus 103.

### 1-4. Inspection Apparatus

The inspection apparatus 103 inspects a sheet on which an image has been formed by the image-forming apparatus 101. In the example of FIG. 1, the inspection apparatus 103 includes a conveyance path 131, a plurality of conveyance rollers 132, a first reading unit 133a, and a second reading unit 133b. The conveyance rollers 132 are conveyance units that convey the sheet accepted from the image-forming apparatus 101 along the conveyance path 131. The first reading unit 133a and the second reading unit 133b are reading units that execute a reading operation. The first reading unit 133a optically reads the first surface of the sheet passing a reading position on the conveyance path 131 to generate a read image of the first surface. The second reading unit 133b optically reads the second surface of the sheet passing a reading position on the conveyance path 131 to generate a read image of the second surface. It should be noted that, in the following descriptions, when there is no need to distinguish the first reading unit 133a and the second reading unit 133b from each other, they are collectively referred to as a reading unit 133. The reading unit 133 may be any type of image sensor such as contact image sensor (CIS), CCD image sensor, or CMOS image sensor, for example. As described in detail below, the inspection apparatus 103 determines whether or not there is a defect on the sheet on which an image has been formed by the image-forming apparatus 101 based on a read image generated by the reading unit 133. A sheet for which no defect has been detected is treated as a normal sheet, and a sheet for which a defect has been detected is treated as a defective sheet. The normal sheet and the defective sheet are output from the inspection apparatus 103 to the stacker 105.

### 1-5. Stacker

The stacker 105 outputs the sheet inspected by the inspection apparatus 103 to either one of a plurality of trays or to the finisher 107 that is downstream of it. In the example of FIG. 1, the stacker 105 includes a conveyance path 151, a stack tray 152, and an escape tray 153. The stack tray 152 is a large-capacity tray on which normal sheets may be stacked. The escape tray 153 is a tray to which a defective sheet may be discharged. The sheet accepted from the inspection apparatus 103 to the conveyance path 151 is discharged to the stack tray 152, discharged to the escape tray 153, or output to the finisher 107 depending on a result of the inspection for the sheet and whether post-processing is needed or not. The stacker 105 may include a sheet-reversing mechanism for switching between face-down discharge and face-up discharge for a sheet to be discharged to the stack tray 152.

### 1-6. Finisher

The finisher 107 is an apparatus that performs post-processing such as stapling, punching, or bookbinding, for example. In the example of FIG. 1, the finisher 107 includes a first post-processing unit 171, a second post-processing unit 172, and discharge trays 173, 174, and 175. The first post-processing unit 171 provides a stapling function and a punching function, for example. The second post-processing unit 172 provides a saddle stitching bookbinding function, for example. A bundle of sheets for which post-processing designated in the print job has been performed is discharged to the discharge tray 173, 174, or 175. Each of the discharge trays 173, 174, and 175 may have an elevating mechanism.

It should be noted that a configuration of the inspection system 100 is not limited to the example shown in FIG. 1. For example, the inspection system 100 does not necessarily include one or more of the inserter 102, the stacker 105 and the finisher 107. In a case where the inspection system 100 does not include the inserter 102, the inspection apparatus 103 is directly coupled downstream of the image-forming apparatus 101.

### 2. Configuration Examples of Control functions

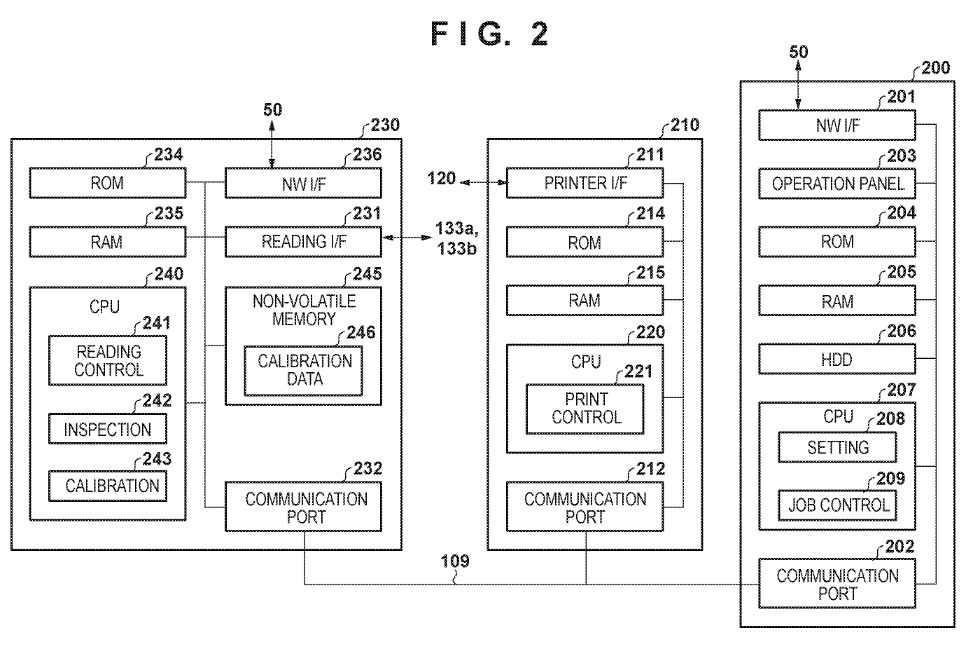

FIG. 1 also shows a main controller 200, a printer controller 210, and a scanner controller 230 that provide control functions of the inspection system 100. The main controller 200, the printer controller 210, and the scanner controller 230 are mutually connected via a system bus 109. It should be noted that each controller may exist not within the controlled apparatus but within another apparatus that can communicate with the controlled apparatus. FIG. 2 is a block diagram showing an example of concrete configurations of these controllers.

### 2-1. Main Controller

With reference to FIG. 2, the main controller 200 includes a NW I/F 201, a communication port 202, an operation panel 203, a ROM 204, a RAM 205, an HDD 206, and a CPU 207. These constituent elements are mutually connected via an internal bus.

The network (NW) interface (I/F) 201 is an interface for the main controller 200 to communicate with an external apparatus (for example, the host computer 10) via the communication network 50. The communication port 202 is a communication unit for communicating with the printer controller 210 and the scanner controller 230 via the system bus 109. The operation panel 203 is an operation unit that provides a user of the inspection system 100 with a user interface. The operation panel 203 may be a combination of a display that displays information and an image and input devices that receive user operations and information inputs, for example. The read-only memory (ROM) 204 stores in advance computer programs for the control function of the main controller 200. The random access memory (RAM) 205 provides the CPU 207 with a temporary storage region for computation. The hard disk drive (HDD) 206 is a large-capacity storage device that can store various data such as input image data, read image data, and inspection results. The central processing unit (CPU) 207 functions as a setting unit 208 and a job control unit 209 by executing the computer programs loaded from the ROM 204 to the RAM 205.

The setting unit 208 is a setting unit that receives user settings related to print jobs. The setting unit 208 causes the host computer 10 or the operation panel 203 to display a setting screen for receiving user settings, and receives the user settings for various setting items on the setting screen, for example. In a case where image inspection by the inspection apparatus 103 is enabled in a print job, the setting unit 208 also receives user settings related to the inspection. Some examples of setting screens provided by the setting unit 208 are further described below.

Upon receiving a print job from the host computer 10, the job control unit 209 instructs the printer controller 210 to execute the print job. In a case where image inspection is enabled for the print job, the job control unit 209 instructs the scanner controller 230 to inspect a sheet on which an image has been formed by the image-forming apparatus 101. The job control unit 209 may further control insertion of sheets by the inserter 102, sorting of sheets by the stacker 105, and application of post-processing to sheets by the finisher 107. The inserter 102, the stacker 105, and the finisher 107 may also have internal controllers that perform local control although they are not shown in FIG. 2.

### 2-2. Printer Controller

The printer controller 210 includes a printer I/F 211, a communication port 212, a ROM 214, a RAM 215, and a CPU 220. These constituent elements are mutually connected via an internal bus.

The printer I/F 211 is an interface for connecting the printer controller 210 to various constituent elements described above of the image-forming unit 120. The communication port 212 is a communication unit for communicating with the main controller 200 and the scanner controller 230 via the system bus 109. The ROM 214 stores in advance computer programs for the control function of the printer controller 210. The RAM 215 provides the CPU 220 with a temporary storage region for computation. The CPU 220 functions as a print control unit 221 by executing the computer programs loaded from the ROM 214 to the RAM 215.

When there is an instruction to execute a print job from the job control unit 209, the print control unit 221 controls the image-forming unit 120 to form an image on a sheet based on input image data. In a case where the print job spans over a plurality of sheets, the sheets are sequentially fed from the paper feeding unit 111a or 111b to the conveyance path 112, and images are formed on respective sheets.

### 2-3. Scanner Controller

The scanner controller 230 includes a reading I/F 231, a communication port 232, a ROM 234, a RAM 235, a NW I/F 236, a CPU 240, and a non-volatile memory 245. These constituent elements are mutually connected via an internal bus.

The reading I/F 231 is an interface for connecting the scanner controller 230 to the reading units 133 (the first reading unit 133a and the second reading unit 133b). The communication port 232 is a communication unit for communicating with the main controller 200 and the printer controller 210 via the system bus 109. The ROM 234 stores in advance computer programs for the control function of the scanner controller 230. The RAM 235 provides the CPU 240 with a temporary storage region for computation. The NW I/F 236 is an interface for the scanner controller 230 to communicate with an external apparatus via the communication network 50. The CPU 240 functions as a reading control unit 241, an inspection unit 242, and a calibration unit 243 by executing the computer programs loaded from the ROM 234 to the RAM 235. The non-volatile memory 245 is a storage unit that can store data persistently.

The reading control unit 241 is a control unit for controlling the reading operation of the reading unit 133. When there is an image inspection instruction from the job control unit 209, for example, the reading control unit 241 controls the reading unit 133 to execute the reading operation for a sheet that is conveyed along the conveyance path 131 and passes the reading position. During the reading operation, the reading unit 133 irradiates the sheet with light from the light-emitting element and reads a reflected light from the sheet to generate a read image.

The inspection unit 242 is an inspection unit that inspects a sheet on which an image has been formed by the image-forming apparatus 101. The inspection unit 242 determines whether or not there is a defect on respective sheets that are subject to the image inspection based on read images generated as a result of the above-described reading operations. The image inspection executed by the inspection unit 242 will be further described below.

The calibration unit 243 is a calibration unit that calibrates the reading operation by the reading unit 133. In the present embodiment, the calibration unit 243 executes calibration processing based on luminance of a reference member measured by the reading unit 133 and generates calibration data 246. The non-volatile memory 245 stores the calibration data 246 generated by the calibration unit 243. In a case where the print job spans over a plurality of sheets, the calibration unit 243 may perform the calibration processing in the middle of execution of the print job to update the calibration data 246.

In the present embodiment, the calibration unit 243 also functions as a correction unit that executes shading correction. The shading correction is processing of mitigating an impact of non-uniformity of light amount or sensitivity in a reading operation to enhance accuracy of the image inspection. For example, the calibration unit 243 may correct an amount of light by which the reading unit 133 irradiates a sheet. Alternatively, the calibration unit 243 may correct read pixel values in a read image generated by the reading unit 133. The calibration data 246 indicates one or both of a gain used for correction of the light amount and a correction coefficient used for correction of the read pixel values. The calibration processing and the shading correction executed by the calibration unit 243 will be further described below.

### 3. Image Inspection

For a print job for which the image inspection is enabled, the inspection unit 242 executes image inspection in accordance with preset inspection items. For example, the inspection unit 242 compares a read image with a correct image that is obtained in advance and determines that there is a defect in the read image in a case where a result of the comparison satisfies a predetermined condition. The correct image may be generated from the input image data by the host computer 10. Alternatively, the correct image may be generated by optically reading a sheet on which the image has been correctly formed.

The inspection unit 242 may also execute variable data inspection. The variable data inspection is an inspection based on matching with variable data that differs on a per-page basis. For the variable data inspection, one or more inspection areas are set in a page for a job that spans over a plurality of pages. The variable data that varies on a per-page basis is associated with each inspection area. Then, the inspection unit 242, for each of the inspection areas, compares the variable data associated with the inspection area with data detected within the inspection area in the read image, and determines whether there is a defect in the sheet based on the comparison result. The data detection within an inspection area may be performed by reading information encoded in a (one-dimensional or two-dimensional) visible code such as a barcode, or may be performed by optical character recognition (OCR), for example.

The inspection unit 242 may also execute front-and-back matching inspection. The front-and-back matching inspection is inspection based on matching between data or an image within an inspection area set on a first surface (front surface) of a sheet and data or an image within an inspection area set on a second surface (back surface) of the sheet. The inspection unit 242, for each pair of inspection areas of the first surface and the second surface, compares data or images detected within the inspection areas, and determines that there is a defect in the sheet in a case where a mismatch is found between them.

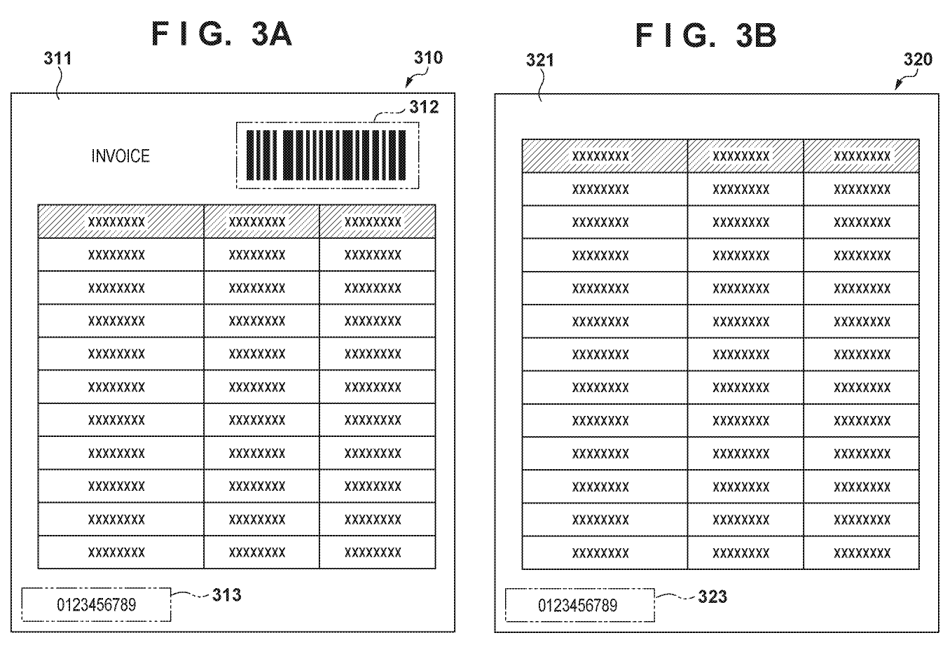

FIGS. 3A and 3B are descriptive diagrams for describing an example of the image inspection executed by the inspection unit 242. FIG. 3A shows a read image 310 of a first surface of a sheet, and FIG. 3B shows a read image 320 of a second surface of the same sheet. The read image 310 includes an image region 311 in which an image is formed based on input image data. Inspection areas 312 and 313 are set in the read image 310. The inspection area 312 is an area for which variable data inspection targeting a one-dimensional barcode is performed. The inspection area 313 is an area for which front-and-back matching inspection based on reading of numerical values is performed. The read image 320 includes an image region 321 in which an image is formed based on input image data. An inspection area 323 is set in the read image 320. The inspection area 323 is an area for which front-and-back matching inspection based on reading of numerical values is performed, and corresponds to the inspection area 313 of the read image 310.

For example, the inspection unit 242 determines that there is a defect in the sheet in a case where the image region 311 of the read image 310 or the image region 321 of the read image 320 includes a part that is different from the correct image. The inspection unit 242 also determines that there is a defect in the sheet in a case where data obtained by decoding the barcode in the inspection area 312 of the read image 310 does not match variable data associated with the inspection area 312 (or in a case where the barcode is not decodable). The inspection unit 242 also determines that there is a defect in the sheet in a case where a numerical value read in the inspection area 313 of the read image 310 does not match a numerical value read in the inspection area 323 of the read image 320. In a case where no defect is detected in any inspection, the inspection unit 242 determines that the sheet is normal.

It should be noted that the image inspection executed by the inspection unit 242 is not limited to the examples described above. For example, the inspection unit 242 may execute inspection on inspection items such as misalignment of an image formation position, page duplication, page skipping, a streaky or dot-like stain in the sheet, or color tone deviation. As there are publicly known methods to perform inspection on such inspection items, descriptions thereof are omitted here. The inspection-related settings such as inspection items, inspection areas, and variable data may be received on an inspection setting screen provided by the setting unit 208.

### 4. Examples of Setting Screens

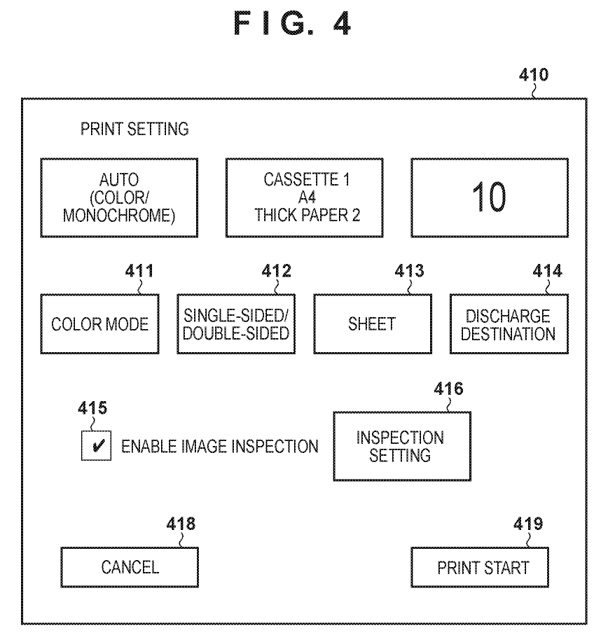

FIG. 4 is a descriptive diagram showing an example of a configuration of a print setting screen 410 for receiving basic user settings related to a print job. With reference to FIG. 4, the print setting screen 410 includes basic setting buttons 411, 412, 413 and 414, a checkbox 415, an inspection setting button 416, a cancel button 418, and a print start button 419.

The basic setting buttons 411, 412, 413 and 414 are buttons for basic user settings related to a print job. For example, the basic setting button 411 is a button for selecting a color mode or a monochrome mode. The basic setting button 412 is a button for selecting single-sided printing or double-sided printing. The basic setting button 413 is a button for selecting a type of sheets to be used for printing. The basic setting button 414 is a button for selecting a tray to which sheets are discharged. The checkbox 415 is an object for setting whether to enable the image inspection or not. If the checkbox 415 is turned on, the image inspection is enabled for the print job that is subject to the settings. The inspection setting button 416 is a button for invoking an inspection setting screen for the print job for which the image inspection is enabled. When the inspection setting button 416 is operated, the setting unit 208 causes the display to display the inspection setting screen 420 described next.

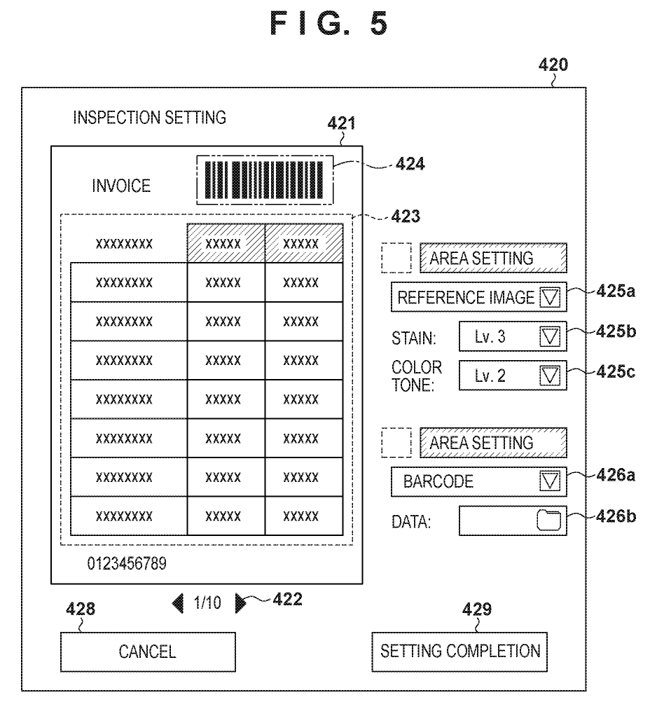

FIG. 5 is a descriptive diagram showing an example of a configuration of the inspection setting screen 420 for receiving user settings related to inspection. With reference to FIG. 5, the inspection setting screen 420 includes a preview section 421, page transition buttons 422, pull-down menus 425a to 425c, a pull-down menu 426a, a file selection field 426b, a cancel button 428, and a setting completion button 429. The preview section 421 is a section in which a preview of an image of each page to be printed is displayed. The page transition buttons 422 are buttons for switching a displayed page in the preview section 421. The user can set an inspection area in a page by dragging over an intended range in the preview section 421, for example. In the example of FIG. 5, two inspection areas 423 and 424 have been set. The pull-down menus 425a to 425c are objects for detailed settings of the inspection area 423. The pull-down menu 426a and the file selection field 426b are objects for detailed settings of the inspection area 424. In the example of FIG. 5, comparison with a reference image has been selected as a type of inspection of the inspection area 423 in the pull-down menu 425a. The pull-down menus 425b and 425c are objects for setting respective inspection levels for inspection on stain and color tone as inspection items based on comparison with the reference image. In addition, variable data inspection based on a barcode has been selected as a type of inspection of the inspection area 424 in the pull-down menu 426a. The file selection field 426b is an object for selecting a data file which describes correct data for the variable data inspection.

The cancel button 428 is a button for canceling changes of the settings on the inspection setting screen 420. When the cancel button 428 is operated, the setting unit 208 discards the changes of the settings, and causes the display to display again the print setting screen 410 of FIG. 4. The setting completion button 429 is a button for receiving an operation that indicates completion of the user settings on the inspection setting screen 420. When the setting completion button 429 is operated, the setting unit 208 reflects the inspection-related user settings received via the inspection setting screen 420 in the print job, and causes the display to display again the print setting screen 410.

Referring back to FIG. 4 for descriptions of the print setting screen 410, the cancel button 418 is a button for closing the print setting screen 410 without starting execution of the print job. The print start button 419 is a button for triggering the start of execution of the print job. For a print job for which the image inspection is enabled, it is made possible to operate the print start button 419 only in a case where the inspection-related settings have been completed on the inspection setting screen 420. When the print start button 419 is operated, the job control unit 209 starts execution of the print job in accordance with the user settings received by the setting unit 208 via the print setting screen 410 (and the inspection setting screen 420).

### 5. Calibration Processing and Shading Correction

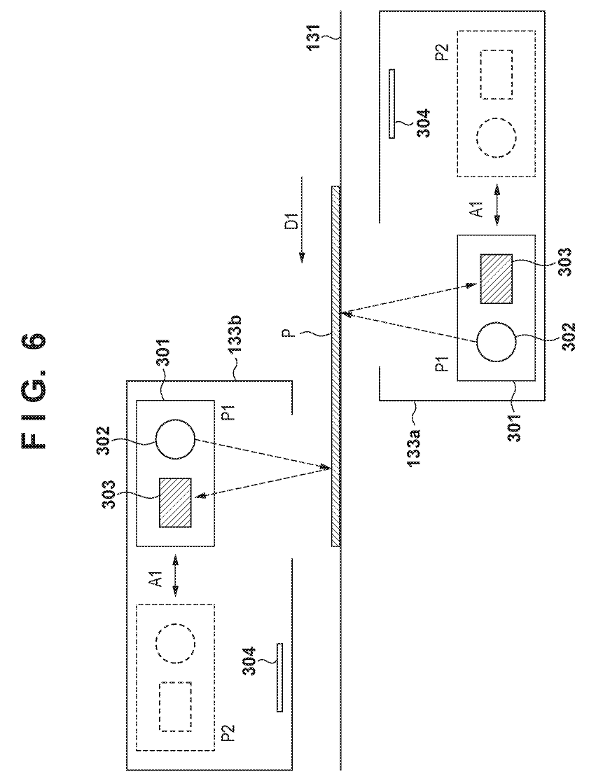

The calibration processing executed by the calibration unit 243 is based on a result of luminance measurement on a reference member by the reading unit 133. FIG. 6 shows an example of configurations of the reading units 133 for measuring luminance of reference members. With reference to FIG. 6, the first reading unit 133a is disposed below the conveyance path 131, and the second reading unit 133b is disposed above the conveyance path 131. As the configuration of the second reading unit 133b may be similar to the configuration of the first reading unit 133a except that it is upside down, only the configuration of the first reading unit 133a will be described here.

The first reading unit 133a includes: a CIS unit 301 that includes a light-emitting element 302 (for example, a light-emitting diode (LED)) and a reading sensor 303; and a reference white plate 304. The CIS unit 301 is driven by a motor (not shown) so that it can move between a reading position P1 and a measurement position P2 in the horizontal direction A1 in the figure.

At the time of executing the reading operation, the CIS unit 301 is located at the reading position P1. When a sheet P is conveyed along the conveyance path 131 in a sub-scanning direction D1 and passes a position facing the CIS unit 301, the light-emitting element 302 irradiates the sheet P with light. The sheet P reflects the irradiation light. The reading sensor 303 reads the reflected light from the sheet P (see broken lines in the figure). The CIS unit 301 generates a read image based on a result of reading over the sheet width (in a main scanning direction that is perpendicular to the sub-scanning direction D1) and the sheet length (in the sub-scanning direction D1), and outputs the generated read image to the CPU 240.

The measurement operation is executed during a time period when the reading unit 133 does not perform the reading operation. At the time of executing the measurement operation, the CIS unit 301 moves from the reading position P1 to the measurement position P2. The reference white plate 304 is disposed such that it faces the CIS unit 301 located at the measurement position P2. During the measurement operation, the light-emitting element 302 irradiates the reference white plate 304 with light. The reference white plate 304 reflects the irradiation light. The reading sensor 303 measures luminance of the reflected light from the reference white plate 304. The CIS unit 301 outputs, to the CPU 240, a result of luminance measurement over the sheet width in the main scanning direction. Upon completing the measurement operation, the CIS unit 301 moves from the measurement position P2 to the reading position P1.

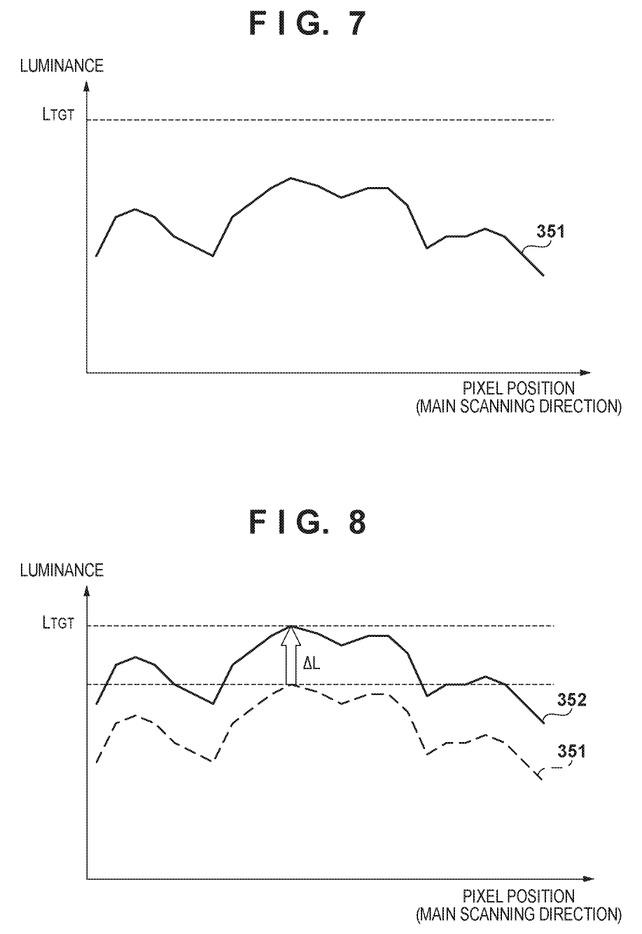

FIG. 7 shows a graph 351 representing an example of a luminance measurement result. The horizontal axis of the graph 351 represents pixel positions in the main scanning direction, and the vertical axis of the graph 351 represents measured luminance values. A target luminance L_{TGT} is a measured value of luminance of an ideal white light that does not depend on pixel positions. As seen from FIG. 7, the graph 351 deviates from the target luminance L_{TGT} at most pixel positions and is not uniform across pixel positions due to non-uniformity of the light amount of the light-emitting element 302 and non-uniformity of the sensitivity per pixel position of the reading sensor 303.

FIG. 8 is a descriptive diagram for describing an example of correction of a light amount using a gain. In FIG. 8, the luminance measurement result before applying light amount correction is indicated by a broken-line graph 351, and a luminance measurement result after applying light amount correction is indicated by a solid-line graph 352. The calibration unit 243 calculates a gain ∆L such that the maximum value of luminance measured during the measurement operation coincides or at least comes close to the target luminance L_{TGT}, for example. The gain ∆L is a control parameter by which an output level of a light amount of the light-emitting element 302 is multiplied. In the example of FIG. 8, as indicated by the graph 352, the light amount of the light-emitting element 302 is amplified using the gain ∆L, and the luminance measurement result has come close to the target luminance L_{TGT} at every pixel position. It should be noted that the value of the target luminance L_{TGT} may be preset in a fixed manner, or may be variably set for each print job.

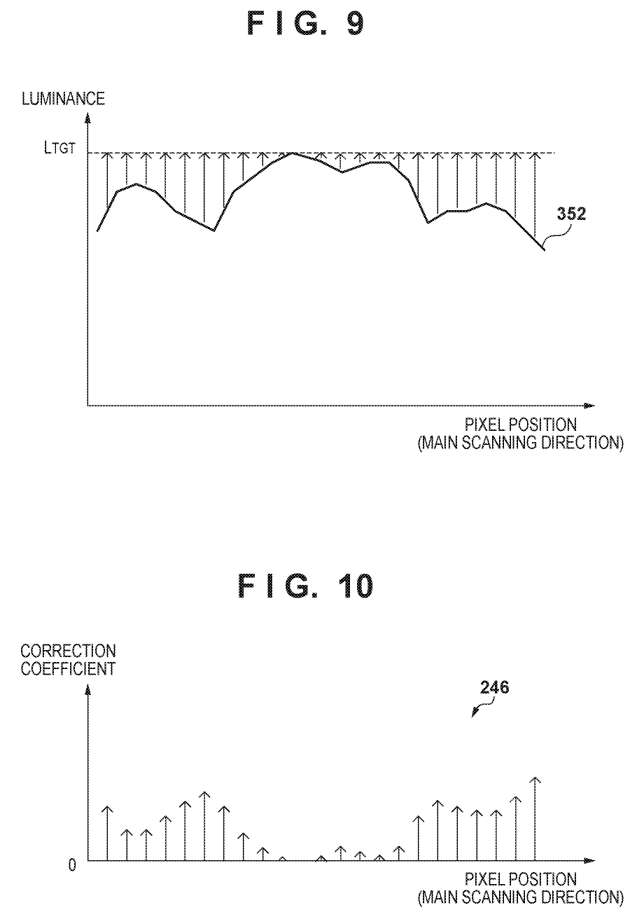

FIGS. 9 and 10 are descriptive diagrams for describing an example of correction of read pixel values using correction coefficients. FIG. 9 shows, conceptually by an arrow, a magnitude of a correction coefficient for each pixel position in the main scanning direction calculated by the calibration unit 243 in addition to the graph 352 and the target luminance L_{TGT}. The calibration unit 243 calculates, for each pixel position, the correction coefficient such that the luminance measurement result coincides with the target luminance L_{TGT}. In FIG. 10, while the horizontal axis represents pixel positions in the main scanning direction as in the case of FIG. 9, the vertical axis represents magnitudes of the correction coefficients. In the example of FIG. 10, the correction coefficient indicates zero at the pixel position at which the luminance measurement result is the closest to the target luminance L_{TGT} in the graph 351, and the correction coefficient indicates a larger value at a pixel position at which a deviation from the target luminance L_{TGT} is larger. The correction coefficients are used in multiplying read pixel values at respective pixel positions of read images generated by the reading unit 133 in reading operations. In this manner, an impact on read images from non-uniformity of the light amount or the sensitivity is mitigated, and the image inspection accuracy is enhanced.

The calibration data 246 generated by the calibration unit 243 in the calibration processing indicates the gain and the correction coefficients determined in this manner. It should be noted that correction of the light amount using the gain may not be performed in the shading correction. In that case, a component corresponding to the gain ∆L shown in FIG. 8 is reflected in the correction coefficients at respective pixel positions.

When the image inspection is repeated for a plurality of sheets in a print job, temperature of the reading unit 133 rises due to heat generated by the light-emitting element 302 of the reading unit 133. The temperature rise continues until an amount of heat generation of the light-emitting element 302 is balanced with an amount of heat absorption due to an airflow in the apparatus and a temperature difference from the ambient temperature outside the apparatus, and finally stops upon reaching a certain temperature. The temperature change during execution of a print job affects reading characteristics of the reading unit 133, and reduces the effect of shading correction using the calibration data 246 that has been once determined. Hence, in order to maintain accuracy of the image inspection within a range that is acceptable to users, the reading control unit 241 causes the reading unit 133 to re-execute the measurement operation when a certain time length has elapsed from a previous measurement operation. In response to re-execution of the measurement operation, the calibration unit 243 updates the calibration data 246. The reading control unit 241 may set a time interval to the next re-execution of the measurement operation to be shorter as a change in measured values of luminance in the measurement operation is larger. In this manner, it is possible to update the calibration data 246 based on a result of the re-execution of the measurement operation before the inspection accuracy falls below the acceptable range.

### 6. Mitigation of Impact of Temperature Change after Starting Print Job

Although good inspection accuracy of the image inspection is maintained by re-executing the measurement operation in the middle of a print job, frequent re-execution of the measurement operation would result in increased downtime during which the reading operation is interrupted and reduced productivity of the print job. Among others, at the beginning of execution of a print job, temperature of the apparatus is unstable and changes relatively rapidly. Conventionally, in order to follow such a temperature change to update the calibration data 246, it has been necessary to re-execute the measurement operation with a short time interval until a sufficient time has elapsed from the start of job execution. In contrast, in the present embodiment, the reading control unit 241 causes the light-emitting element 302 of the reading unit 133 to start preliminary light emission prior to the initial measurement operation before starting a print job. The preliminary light emission raises the temperature of the reading unit 133 until the initial measurement operation, which makes temperature rise after the initial measurement operation moderate. As such, it is possible to set a time interval to subsequent re-execution of the measurement operation to be longer than that in the past.

Specifically, the reading control unit 241 causes the reading unit 133 to start preliminary light emission from the light-emitting element 302 in response to the setting unit 208 receiving a user setting related to inspection, for example. In general, there is a time difference between an operation for receiving an inspection-related user setting and an operation for triggering the start of execution of a print job. Therefore, by exploiting the time difference for the preliminary light emission of the light-emitting element 302, it is possible to secure sufficient time to preheat the reading unit 133 without introducing a delay of operation after the start of execution of a print job is triggered.

The operation for receiving an inspection-related user setting may be, for example, the operation of the setting completion button 429 of the inspection setting screen 420 described above. That is, in response to the operation of the setting completion button 429 on the inspection setting screen 420, the reading control unit 241 causes the reading unit 133 to start preliminary light emission from the light-emitting element 302 prior to the following start of execution of a print job. After operating the setting completion button 429, the user checks that the other user settings have been done appropriately on the print setting screen 410, and further operates the print start button 419. In response to this further operation, the reading control unit 241 instructs the reading unit 133 to execute its initial measurement operation. The reading unit 133 stops the preliminary light emission from the light-emitting element 302, and executes the initial measurement operation. Then, the print control unit 221 starts execution of the print job.

It should be noted that the operation for receiving an inspection-related user setting is not limited to the operation of the setting completion button 429. For example, the preliminary light emission from the light-emitting elements 302 may be started in response to another type of operation on the inspection setting screen 420.

A light amount level of a light-emitting element 302 in the preliminary light emission before the initial measurement operation (hereinafter, referred to as a first light amount level) may be set to be higher than a light amount level of the light-emitting element 302 in the measurement operation (hereinafter, referred to as a second light amount level). While the second light amount level set in the measurement operation is constrained to be a light amount that is suitable for the calibration processing, there is no such constraint on the preliminary light emission. Therefore, by setting the first light amount level in the preliminary light emission to a higher value than the second light amount level, it is possible to preheat the reading unit 133 efficiently in a small amount of time.

In a certain embodiment example, the reading unit 133 includes a switching element disposed between a power supply circuit and the light-emitting element 302. The reading control unit 241 controls the light amount of the light-emitting element 302 through pulse width modulation (PWM) by varying a pulse width of an LED drive signal that is a pulse signal for opening and closing the switching element. In this embodiment example, a light amount difference between the first light amount level and the second light amount level is based on a difference in a duty ratio in PWM. The reading control unit 241 may set the duty ratio of PWM to 100% when it causes the light-emitting element 302 to emit light at the first light amount level in the preliminary light emission. In this manner, it is possible to maximize efficiency of the temperature rise of the reading unit 133 in the preliminary light emission. In another embodiment example, the reading control unit 241 may control the light amount of the light-emitting element 302 in a variable manner by varying the voltage applied to the light-emitting element 302 to adjust an amount of current supplied to the light-emitting element 302.

The preliminary light emission of the light-emitting element 302 at the first light amount level is continued until the initial measurement operation is started. The reading control unit 241 may monitor the elapsed time from the start of the preliminary light emission by a timer, and stop the preliminary light emission from the light-emitting element 302 when a print job is not started within a predetermined time period. In a case where the start of execution of a print job will be triggered by a further user operation as in the above-described example, there is a possibility that the user operation is not performed and thus the print job is canceled. Therefore, by imposing an upper limit on the time for which the preliminary light emission of the light-emitting element 302 is continued, it is possible to avoid a situation in which the preliminary light emission is continued and power is wasted despite the cancelation of the print job.

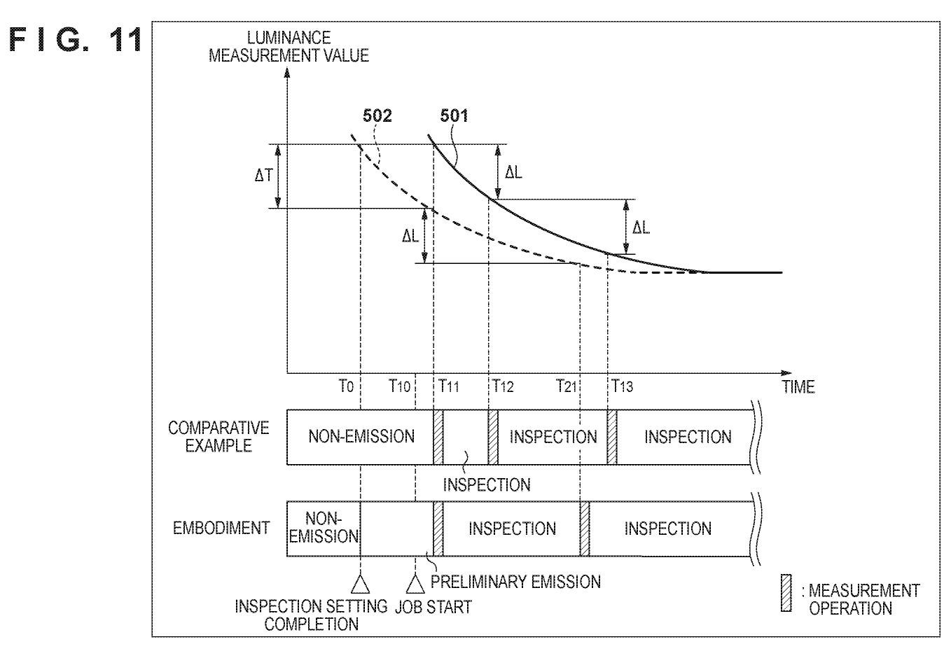

FIG. 11 is a descriptive diagram for describing enhancement of productivity by the preliminary light emission in the above-described embodiment by comparison with a comparative example. The graphs 501 and 502 shown in the upper portion of FIG. 11 have a horizontal axis representing time progression, and a vertical axis representing a luminance measurement value for the reference member. Note that the scale of the luminance measurement value is exaggerated here so as to illustrate how it changes in an easily understood manner.

The graph 501 represents temporal change in the luminance measurement value in the comparative example. In the comparative example, the start of execution of a print job is triggered at time T₁₀, and then an initial measurement operation is executed at time T₁₁. Before the initial measurement operation, the light-emitting element 302 of the reading unit 133 does not emit light. From time T₁₁ to time T₁₂, the image-forming apparatus 101 sequentially forms images on a plurality of sheets, and the inspection apparatus 103 inspects those sheets. The temperature of the reading unit 133 rises through repetitions of the reading operation, and the characteristics of the reading unit 133 change accordingly. ∆L in the figure indicates a degree of decrease in the luminance measurement value from time T₁₁ to time T₁₂, which corresponds to a magnitude of the change in the characteristics of the reading unit 133. The reading control unit 241 causes the reading unit 133 to re-execute the measurement operation at time T₁₂ in order to maintain the accuracy of the image inspection. From time T₁₂to time T₁₃, the image-forming apparatus 101 sequentially forms images on a further plurality of sheets, and the inspection apparatus 103 inspects those sheets. The temperature of the reading unit 133 rises through repetitions of the reading operation, but the rate of rising gradually becomes moderate. The reading control unit 241 causes the reading unit 133 to re-execute the measurement operation at time T₁₃ in order to avoid degradation in the accuracy of the image inspection.

On the other hand, the graph 502 represents temporal change in the luminance measurement value in the above-described embodiment. In response to the operation indicating completion of the user settings on the inspection setting screen 420, at time T₀, the reading control unit 241 causes the reading unit 133 to start preliminary light emission from the light-emitting element 302. Then, when the start of execution of a print job is triggered at time T₁₀, the reading control unit 241 causes the reading unit 133 to execute an initial measurement operation at time T₁₁. From time T₀ to time T₁₁, the temperature of the reading unit 133 rises due to the light emission of the light-emitting element 302. ∆T in the figure indicates a degree of decrease in the luminance measurement value from time T₀ to time T₁₁, which corresponds to a magnitude of the change in the characteristics of the reading unit 133. Upon starting execution of the print job, the image-forming apparatus 101 sequentially forms images on a plurality of sheets, and the inspection apparatus 103 inspects those sheets. The temperature of the reading unit 133 rises through repetitions of the reading operation, and the characteristics of the reading unit 133 change accordingly. From time T₁₁ to time T₂₁, the degree of decrease in the luminance measurement value reaches ∆L. The reading control unit 241 causes the reading unit 133 to re-execute the measurement operation at time T₂₁ in order to maintain the accuracy of the image inspection.

Compared to the graph 501, as a result of preheating before time T₁₁, in the graph 502, the temperature change after T₁₁ slows down. Hence, for the graph 502, the time from the initial measurement operation to re-execution of the measurement operation can be relatively longer, and downtime during which no image inspection is performed does not exist between them. In this manner, in the above-described embodiment, the impact of the temperature change after starting a print job is mitigated, and frequent re-execution of the measurement operation is avoided, which enhances productivity of the print job.

### 7. Flows of Inspection Control Processing

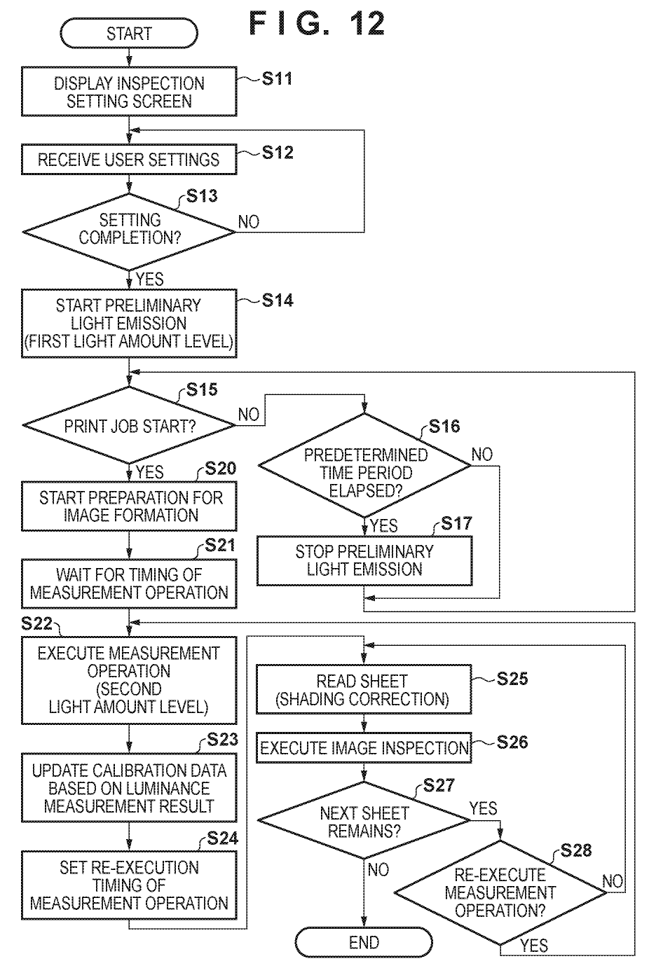

FIG. 12 is a flowchart showing an example of a flow of inspection control processing according to the above-described embodiment. The inspection control processing of FIG. 12 may be started in response to a user operation for invoking the inspection setting screen 420 on the print setting screen 410. In the following descriptions, 'S' is an abbreviation of a processing step.

First, in S11, the setting unit 208 causes a display apparatus to display the inspection setting screen 420. Next, in S12, the setting unit 208 receives user settings related to inspection on the inspection setting screen 420. In S13, the setting unit 208 waits for completion of the user settings related to inspection. When the operation indicating completion of the user settings is performed on the inspection setting screen 420, the processing proceeds to S14.

In S14, the reading control unit 241 causes the reading unit 133 to start the preliminary light emission. The light-emitting element 302 of the reading unit 133 starts light emission at the first light amount level. In the meantime, in S15, the setting unit 208 causes the display apparatus to display the print setting screen 410, and waits for the operation for triggering the start of execution of a print job. Meanwhile, in S16, the reading control unit 241 monitors the elapsed time from the start of the preliminary light emission. When a predetermined time period has elapsed from the start of the preliminary light emission, in S17, the reading control unit 241 causes the reading unit 133 to stop the preliminary light emission.

Irrespective of whether the preliminary light emission is ongoing or has been stopped, when the operation for triggering the start of execution of a print job is performed on the print setting screen 410, the processing proceeds to S20. In S20, the print control unit 221 causes the image-forming unit 120 to start preparing for an image-forming operation. Meanwhile, in S21, the reading control unit 241 causes the reading unit 133 to wait for a timing of an initial measurement operation. The timing of the initial measurement operation may be determined as, for example, a timing preceding, by a time required for one measurement operation, the timing at which the first sheet on which an image has been formed by the image-forming unit 120 arrives at the inspection apparatus 103.

When the timing of the initial measurement operation comes, in S22, the reading control unit 241 causes the reading unit 133 to execute the measurement operation. The CIS unit 301 moves from the reading position P1 to the measurement position P2, and irradiates the reference white plate 304 with light at the second light amount level to measure luminance of a reflected light. In S23, the calibration unit 243 updates the calibration data 246 based on a result of the luminance measurement. The CIS unit 301 returns from the measurement position P2 to the reading position P1.

Next, in S24, the reading control unit 241 sets a timing of re-execution of the measurement operation. Timing of re-execution of the measurement operation may be predetermined such that a time length to the next re-execution is lengthened each time the re-execution is repeated, for example. The reading control unit 241 may measure time duration of the preliminary light emission, and set a time length from the initial measurement operation to the first re-execution of the measurement operation to be longer as the time duration is longer. This is because, if the preliminary light emission continues for a longer time, the temperature of the reading unit 133 will be higher at the time point of the first measurement operation, and the temperature will rise more moderately thereafter. The reading control unit 241 may set the time lengths to the second and subsequent measurement operations dynamically based on results of the measurement operation in S22. For example, by setting a time length to the next re-execution of the measurement operation to be longer as an amount of change in the measured value from the previous measurement result is smaller, it is possible to enhance productivity while avoiding degradation in inspection accuracy.

Next, in S25, the reading control unit 241 causes the reading unit 133 to execute the reading operation when a sheet on which an image has been formed by the image-forming apparatus 101 arrives at the reading position. The reading unit 133 optically reads the sheet to generate a read image. The calibration unit 243 executes the shading correction on the read image in accordance with the correction coefficients indicated by the calibration data 246. For example, the calibration unit 243 corrects one or both of the light amount with which the reading unit 133 irradiates the sheet and read pixel values in the read image so as to mitigate an impact of non-uniformity in the light amount or sensitivity in the reading operation.

Next, in S26, the inspection unit 242 executes the image inspection based on the read image after the shading correction to determine whether the sheet is a normal sheet or a defective sheet. The inspection unit 242 outputs a result of the image inspection to the job control unit 209.

Next, in S27, the reading control unit 241 determines whether there remains a next sheet to be processed in the print job or not. In a case where there remains a next sheet, in S28, the reading control unit 241 determines whether the timing of re-execution of the measurement operation determined in S24 has come or not. In a case where the timing of re-execution of the measurement operation has come, the processing goes back to S22, and the measurement operation is re-executed by the reading unit 133, and the calibration data 246 is updated by the calibration unit 243. In a case where the timing of re-execution of the measurement operation has not come, the processing goes back to S25, and sheet reading, the shading correction, and the image inspection are executed for the next sheet as a target. In a case where there remains no next sheet, the inspection control processing of FIG. 12 ends.

### 8. Conclusion

Thus far, embodiments of the technology according to the present disclosure have been described in detail with reference to FIGS. 1 to 12. In the above-described embodiments, in an inspection system with a reading unit that optically reads a sheet on which an image has been formed to inspect the sheet, before accepting the sheet into the reading unit, a measurement operation to measure luminance of a reference member is executed by the reading unit for calibration of the reading operation. In particular, a light-emitting element of the reading unit starts light emission after a user setting related to the inspection is received and before the initial measurement operation is executed. According to such a configuration, since the temperature of the reading unit has risen to some extent at the time point of the initial measurement operation prior to a start of execution of a print job, the rate of temperature rise after the start of execution of the print job becomes moderate. Consequently, the characteristics of the reading unit in the middle of execution of the print job become more stable, and a longer time interval of re-execution of the measurement operation can be set. In this manner, the impact of changes in temperature of an apparatus after starting a print job is mitigated and frequent re-execution of the measurement operation is avoided, which allows the achievement of both of good inspection accuracy and high productivity.

In addition, in the above-described embodiments, the light-emitting element of the reading unit starts light emission in response to reception of a user setting related to the inspection. The light-emitting element of the reading unit starts the light emission before receiving an instruction to start the print job. Therefore, sufficient time to preheat the reading unit can be secured during a time period from reception of the user setting related to the inspection to the start of execution of the print job.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

What is claimed is:

1. An inspection system comprising:
a conveyance unit configured to convey a sheet on which an image has been formed by an image-forming apparatus;
a reading unit configured to execute a reading operation to irradiate the sheet with light from a light-emitting element and read a reflected light from the sheet;
an inspection unit configured to inspect the sheet based on a read image generated as a result of the reading operation;
a control unit configured to cause the reading unit to execute a measurement operation to irradiate a reference member with light from the light-emitting element and measure luminance of a reflected light from the reference member before the conveyance unit accepts the sheet;
a calibration unit configured to generate calibration data to be used in calibrating the reading operation based on a result of the measurement operation; and
a setting unit configured to receive a user setting related to the inspection at the inspection unit,
wherein the control unit is configured to cause the light-emitting element to start light emission after the setting unit receives the user setting related to the inspection and before the control unit causes the reading unit to execute the measurement operation.

2. The inspection system according to claim 1, wherein the control unit is configured to cause the light-emitting element to start the light emission in response to the setting unit receiving the user setting related to the inspection.

3. The inspection system according to claim 1, wherein the control unit is configured to cause the light-emitting element to start the light emission before the setting unit receives an instruction to start a job for forming the image on the sheet.

4. The inspection system according to claim 1, wherein the light emission by the light-emitting element is a preliminary light emission before the measurement operation.

5. The inspection system according to claim 4, wherein a first light amount level of the light-emitting element in the preliminary light emission is higher than a second light amount level of the light-emitting element in the measurement operation.

6. The inspection system according to claim 5, wherein the preliminary light emission of the light-emitting element at the first light amount level is continued until the measurement operation is started.

7. The inspection system according to claim 6, wherein the control unit is configured to cause the light-emitting element to stop the preliminary light emission when a job for forming the image on the sheet is not started within a predetermined time period from a start of the preliminary light emission.

8. The inspection system according to claim 5, wherein a light amount of the light-emitting element is controlled through pulse width modulation, and
a light amount difference between the first light amount level and the second light amount level is based on a difference in a duty ratio in the pulse width modulation.

9. The inspection system according to claim 1, wherein the setting unit is configured to cause a display apparatus to display a setting screen for receiving the user setting related to the inspection, and
the control unit is configured to cause the light-emitting element to start the light emission in response to an operation on the setting screen, the operation indicating completion of the user setting.

10. The inspection system according to claim 9, wherein the setting screen includes a button to receive the operation indicating completion of the user setting.

11. The inspection system according to claim 9, wherein, after the operation indicating completion of the user setting related to the inspection is performed on the setting screen, a job for forming the image on the sheet is started in response to a further operation by a user.

12. The inspection system according to claim 1, wherein the control unit is configured to cause the reading unit to re-execute the measurement operation during a time period when the reading unit does not perform the reading operation, and the longer a time duration of the light emission is, the longer a time length to a first re-execution of the measurement operation is set to be.

13. The inspection system according to claim 1, wherein the calibration unit is configured to correct one or both of a light amount with which the reading unit irradiates the sheet and a read pixel value in the read image in accordance with the calibration data so as to mitigate an impact of non-uniformity in a light amount or sensitivity in the reading operation.

14. The inspection system according to claim 1, further comprising the image-forming apparatus.
